(19) United States
(12) Patent Application Publication
(10) Pub. No.: US 2024/0222924 A1
(43) Pub. Date: Jul. 4, 2024

(54) AUTOMATED HIGH VOLTAGE CABLE CRIMPING SYSTEM AND METHOD

(71) Applicant: ELECTRICAL COMPONENTS INTERNATIONAL, INC., St. Louis, MO (US)

(72) Inventor: Kyryll Zaytsev, Saint-Laurent (CA)

(21) Appl. No.: 18/392,195

(22) Filed: Dec. 21, 2023

Related U.S. Application Data
(60) Provisional application No. 63/436,275, filed on Dec. 30, 2022.

(51) Int. Cl. H01R 43/055

(52) U.S. Cl. CPC H01R 43/055

(57) ABSTRACT

A method of securing a lug to a wire includes the steps of supporting a wire at a location that is spaced from a stripped end of a wire, placing a lug in a lower lug support, mounting an upper lug support onto the lower lug support to retain the lug between the lower and upper lug supports, pushing the stripped end through a cone and into a shaped cylindrical passage that is provided by the lower and upper lug supports, the shaped cylindrical passage compresses the stripped end, and inserting the compressed stripped end into an open end of the lug.

### CROSS-REFERENCE TO RELATED APPLICATION

This application claims priority to U.S. Provisional Application No. 63/436,275 filed Dec. 30, 2022.

### TECHNICAL FIELD

This disclosure relates to a fully automated crimping system and method for securing a lug or other terminal to a stripped end of a wire, for example, for use in high voltage cable applications.

### BACKGROUND

Wire terminals, such as lugs, are secured to a stripped end of the wire in single cable or as part of a wiring harness. The assembly of a typical cable or wiring harness involves extensive handling by humans, particularly in low production volumes. Not only is such handling relatively slow and expensive, but this handling can lead to defects that are difficult to detect in a production environment. This is particularly problematic for high voltage wiring applications used in electrified vehicles, where any very minor defect can lead to a failure of the high voltage cable in the field.

What is needed is a fully automated, reliable crimping system that enables visual monitoring of at least one of the wire and the lug during the assembly process to ensure a defect-free quality crimp.

### SUMMARY

In one exemplary embodiment, a method of securing a lug to a wire includes the steps of supporting a wire at a location that is spaced from a stripped end of a wire, placing a lug in a lower lug support, mounting an upper lug support onto the lower lug support to retain the lug between the lower and upper lug supports, pushing the stripped end through a cone and into a shaped cylindrical passage that is provided by the lower and upper lug supports, the shaped cylindrical passage compresses the stripped end, and inserting the compressed stripped end into an open end of the lug.

In a further embodiment of any of the above, the supporting step includes retaining the wire at least two locations that are spaced apart from one another along a length of the wire.

In a further embodiment of any of the above, the placing step includes robotically picking the lug from a lug feeder.

In a further embodiment of any of the above, the mounting step includes aligning the upper lug support to the lower lug support with at least one alignment feature.

In a further embodiment of any of the above, the at least one alignment feature includes at least one of a magnet and ferrous material, a complementary interlocking tab and notch, and a pin with a complementarily shaped hole.

In a further embodiment of any of the above, the mounting step includes capturing an end of the lug that has an opening with a protrusion that is provided in at least one of the lower and upper lug supports and extends through the opening.

In a further embodiment of any of the above, the cone has first and second diameters. The first diameter is greater than the second diameter, and the shaped cylindrical passage has third and fourth diameters. The third diameter is greater than the fourth diameter. The pushing step includes sliding the stripped end from the first diameter, through the second and third diameters and past the fourth diameter.

In a further embodiment of any of the above, the shaped cylindrical passage includes an annular radius that provides a transitional portion from the third diameter to the fourth diameter.

In a further embodiment of any of the above, the method includes the steps of seating the stripped end into the lug against a stop, and crimping the lug onto the seated wire.

In another exemplary embodiment, a lug support assembly for supporting a lug during insertion of a stripped end of a wire includes a lower lug support with a recess that is configured to receive a lug. An upper lug support is configured to be mounted onto the lower lug support. An alignment feature is provided between the lower and upper lug supports. A cone is provided by the lower and upper lug supports. A shaped cylindrical passage is provided by the lower and upper lug supports. The shaped cylindrical passage interconnects the cone to the recess. The cone and the shaped cylindrical passage provide a wire insertion passage that has a reduced cross-sectional area that extends to the recess.

In a further embodiment of any of the above, the alignment feature includes a magnet that is provided on one of the lower and upper lug supports. The alignment feature includes a ferrous material that is provided on the other of the lower and upper lug supports. The magnet and the ferrous material mate with one another in a closed lug support assembly configuration.

In a further embodiment of any of the above, the alignment feature includes a tab that provides a portion of the cone on one of the lower and upper lug supports. The alignment feature includes a complementary interlocking notch that is provided on the other of the lower and upper lug supports. The tab and the notch mate with one another in a closed lug support assembly configuration.

In a further embodiment of any of the above, the alignment feature includes a pin that is provided on one of the lower and upper lug supports. The alignment feature includes a complementarily shaped hole that is provided on the other of the lower and upper lug supports. The pin and the hole mate with one another in a closed lug support assembly configuration.

In a further embodiment of any of the above, the cone has first and second diameters. The first diameter is greater than the second diameter, and the shaped cylindrical passage has third and fourth diameters. The third diameter is greater than the fourth diameter, and the shaped cylindrical passage includes an annular radius that provides a transitional portion from the third diameter to the fourth diameter.

In a further embodiment of any of the above, a window is arranged in the upper lug support and in communication with the recess and includes a bracket on the upper lug support to which a camera is mounted. The camera is aimed at the window and configured to monitor an interface between a stripped end of a wire and an open end of the lug.

In another exemplary embodiment, a wire lug crimping system includes a wire support assembly that is configured to retain a portion of a wire. A lug feeder is configured to supply lugs to a lug picking location. A lug support assembly includes lower and upper lug supports, the lower lug support with a recess that is configured to receive a lug. The upper lug support is configured to be mounted onto the lower lug support, and an alignment feature is provided between the lower and upper lug supports. A wire lug crimper is configured to crimp the lug onto a stripped end of the wire. At least one robotic arm is configured to move the lug from the picking location into the recess, move the upper lug support onto and off of the lower lug support, insert the stripped end of the wire into an open end of the lug, and drag the lug with the inserted stripped end from the lower lug support to the wire lug crimper. Multiple cameras are arranged at multiple inspection locations that include the lug support assembly and the wire lug crimper. The cameras are configured to visually monitor at least one of the wire and the lug.

In a further embodiment of any of the above, the wire support assembly includes multiple wire supports that are spaced apart from one another. Each wire support includes first and second wire supports that are configured to be secured about the wire. The multiple wire supports are arranged on a conveyor and configured to move between multiple discrete positions.

In a further embodiment of any of the above, one of the at least one robotic arm is configured to move at least one of the second wire supports between first and second positions. The first position has the second wire support on the first wire support, and the second position has the second wire support removed relative to the wire support half.

In a further embodiment of any of the above, one of the cameras is mounted to the upper lug support via a bracket. The camera is aimed at a window in the upper lug support. The window provides visual access to an interface between the stripped end and the open end of the lug.

In a further embodiment of any of the above, a cone is provided by the lower and upper lug supports, and a shaped cylindrical passage is provided by the lower and upper lug supports. The shaped cylindrical passage interconnects the cone to the recess. The cone and the shaped cylindrical passage provides a wire insertion passage that has a reduced cross-sectional area that extends to the recess.

### BRIEF DESCRIPTION OF THE DRAWINGS

The disclosure can be further understood by reference to the following detailed description when considered in connection with the accompanying drawings wherein:

FIG. 1 is a perspective view of a wire lug crimping system.

FIG. 2 illustrates a lug robotically picked and placed in a lower lug support.

FIGS. 3A and 3B respectively depict perspective and plan views of the lower lug support.

FIG. 4 illustrates an upper lug support robotically placed on the lower lug support with a camera for monitoring insertion of a stripped end of a wire into a lug.

FIGS. 5A, 5B and 5C depict a lug support assembly with the upper lug support mounted to the lower lug support, a cross-sectional view of the upper lug support, and an end view of a cone used to guide the stripped end into an open end of the lug.

FIG. 6 illustrates the wire robotically inserting the stripped end through the cone and a shaped cylindrical passage into the open end of the lug.

FIG. 7 shows the upper lug support returned to its pedestal, and the stripped end partially inserted into the lug.

FIG. 8 depicts the robot about to push the lug into a crimper.

FIG. 9 illustrates the lug being pushed through a cone provided in the crimper.

FIG. 10 shows the lug abutting a stop to fully seat the stripped end into the lug.

FIG. 11 depicts the crimper crimping the lug onto the stripped end.

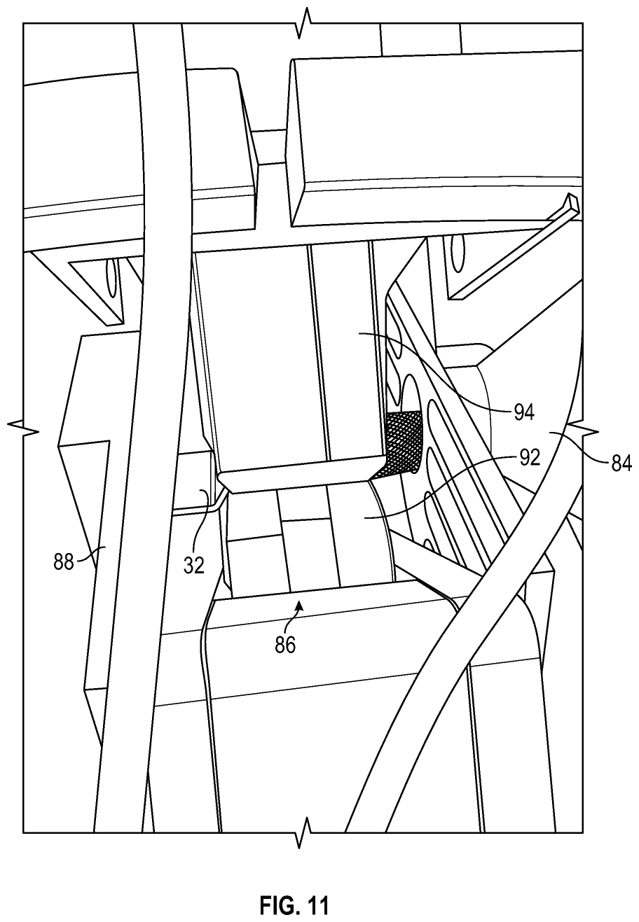

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

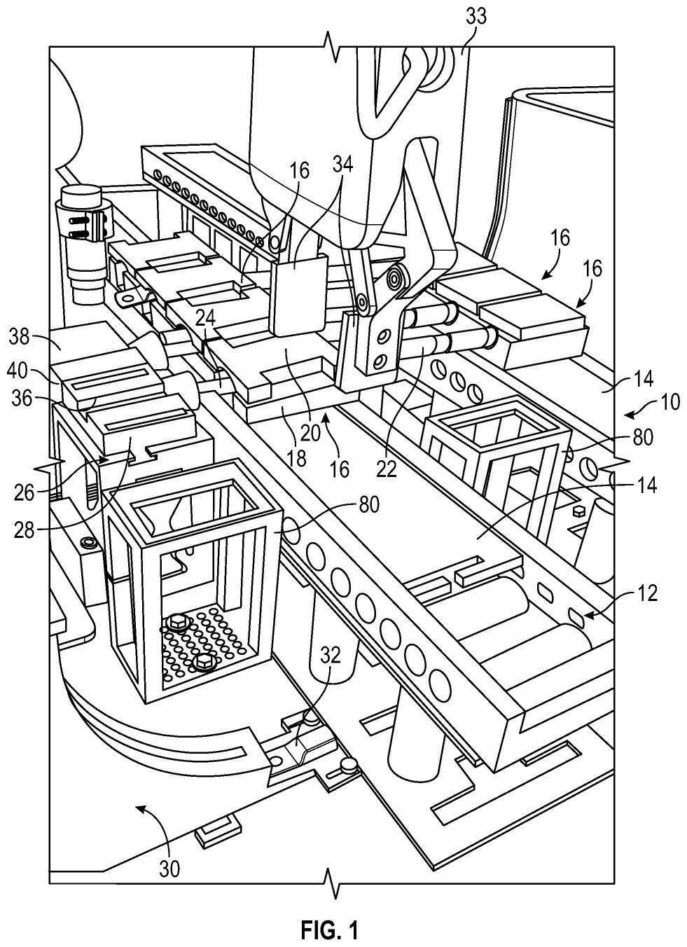

A wire lug crimping system 10 is shown in FIG. 1, which enables full automation and inspection of the wire crimping process. This enables a no human contact assembly process, particularly for high voltage crimp operations, which is especially useful in meeting the defect-free requirements of a high voltage harness (single cable or multiple cables in a wiring harness). The lug and wire are supported in a manner for reliable and repeatable robotic gripping and for placement of inspection cameras, such as those used in Applicant's KonnectAI system.

The system 10 includes a conveyor 12 having parallel, spaced apart tracks 14. In the example, each track 14 supports multiple wire support assemblies 16, which are used to retain the wire 22 in a predictable manner for robot gripping. The conveyor 12 can index the tracks 14 as one wire crimp is completed, enabling a continuous process. Each wire support assembly 16 includes first (e.g., lower) and second (e.g., upper) wire supports 18, 20 mounted to one another and secured about the wire to prevent sagging of the wire. The terms “lower” and “upper” throughout this disclosure should not be construed as limiting, but rather as example relative locations, which may be varied from the configuration disclosed. Other wire support configurations may be used than shown.

A lug feeder 30 supply lugs 32 to a lug picking location, as shown in FIG. 1, from which a robotic arm 33 with jaws 34 picks and places the lug 32 into a recess 36 of a lower lug support 28. A lug support assembly 26, which includes a dovetail arrangement 27 for mounting, includes lower and upper lug supports 28, 38. The dovetail arrangement 27 enables other support assemblies to be quickly and easily placed into the system 10 to accommodate different sizes and/or terminal configurations. In the arrangement illustrated in FIG. 1, the upper lug support 38 is temporarily located on a pedestal 40 adjacent to the lower lug support 28 to enable placement of the lug 32 into the recess 36.

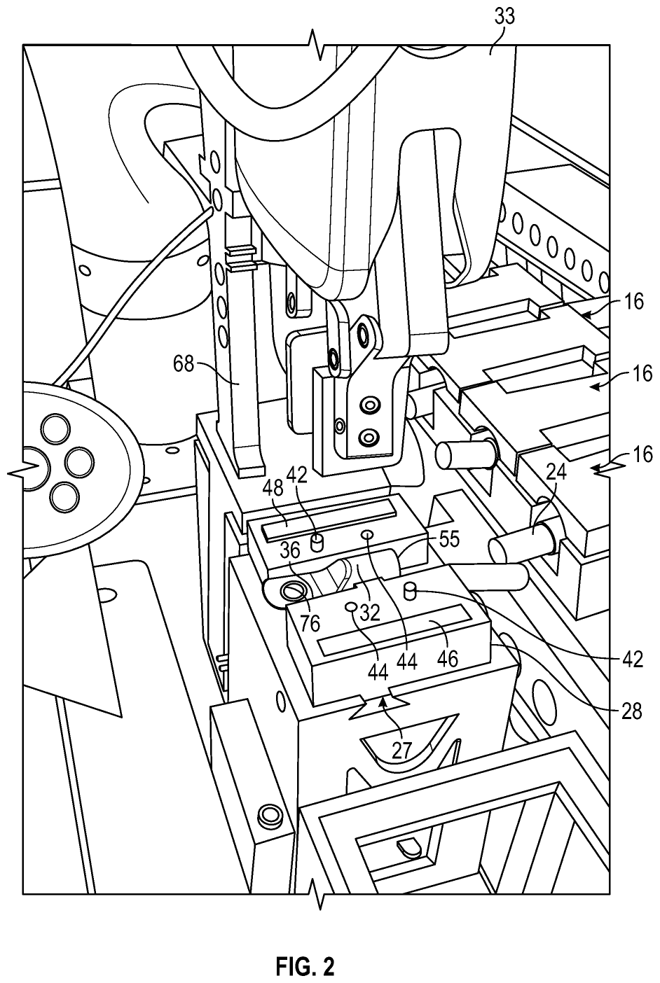

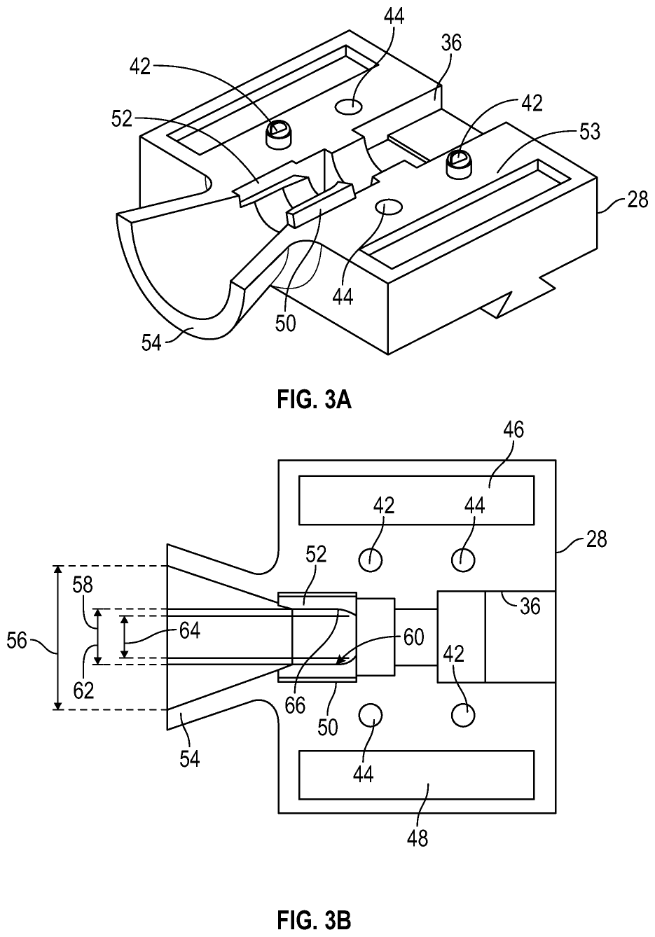

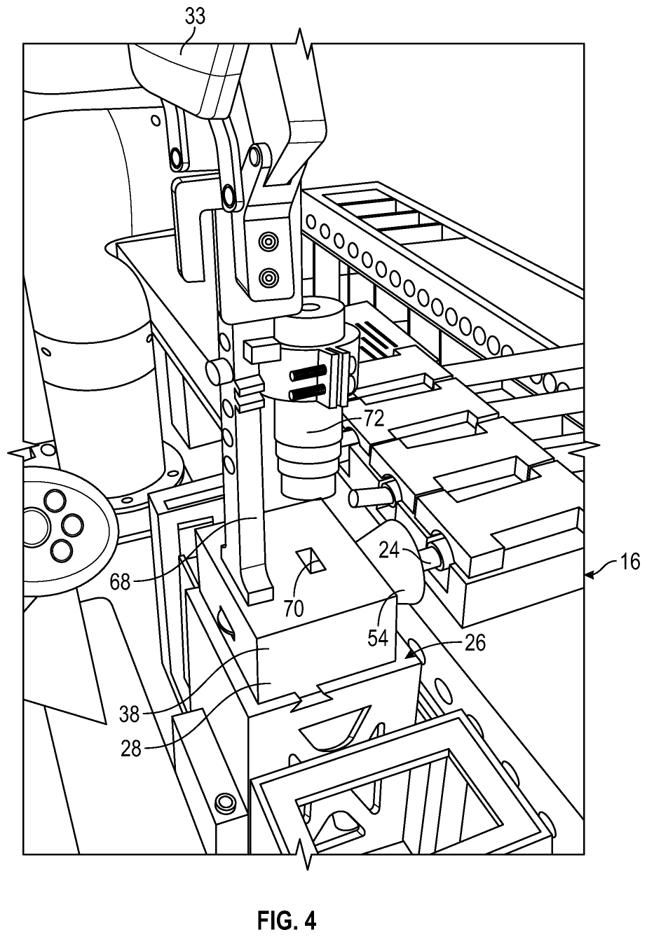

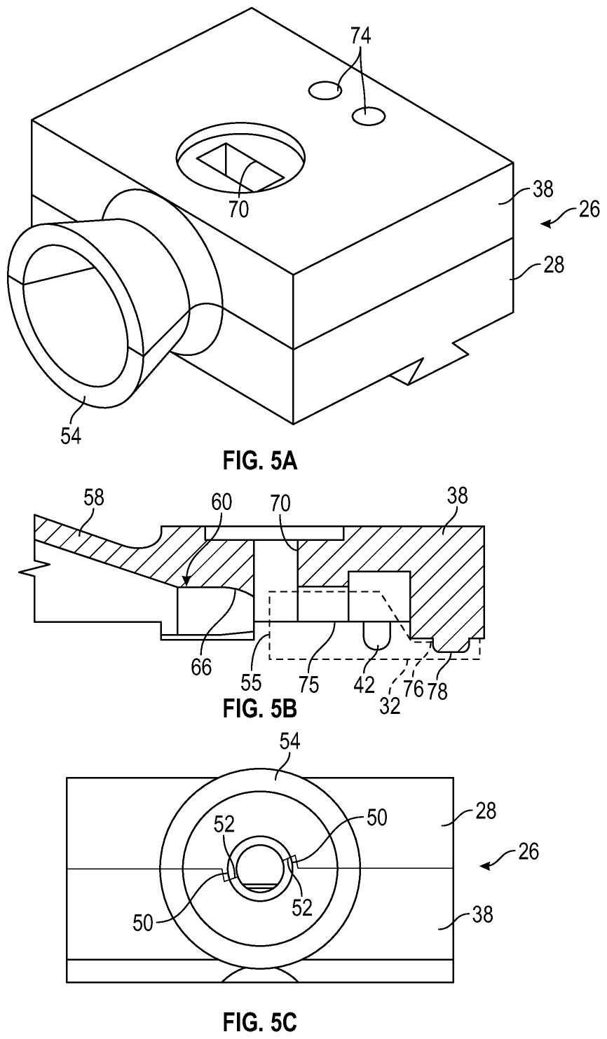

Referring to FIGS. 2-3B, the lower lug support 28 (and upper lug support, as shown in FIGS. 5A-5C) include one or more alignment features provided between the lower and upper lug supports, which ensure desired orientation and retention of the upper lug support 38 relative to the lower lug support 28. A first alignment feature includes a pin 42 provided on one of the lower and upper lug supports 28, 38 (one in each in the example), which mate with a complementarily shaped hole 44 provided on the other of the lower and upper lug supports 28, 38 (one in each in the example) when in a closed lug support assembly configuration (see FIG. 4). Lower and upper mating surfaces 53, 75 of the lower and upper lug supports 28, 38 engage one another in the closed lug support assembly configuration. This pin/hole arrangement prevents clocking of the lower and upper lug supports 28, 38 relative to one another.

A second alignment feature includes a magnet 46 provided on one of the lower and upper lug supports 28, 38 (one in each in the example), and a ferrous material 48 is provided on the other of the lower and upper lug supports 28, 38 (one in each in the example). The magnet 46 and the ferrous material 48 mate with one another in the closed lug support assembly configuration to prevent the upper lug support 38 from separating from the lower lug support 28 during insertion of the stripped end 24 into the lug 32. The robotic arm 33 may continue to apply a downward pressure to the upper lug support 38 during this step, if desired.

Referring to FIGS. 3A-4, a cone 54 is provided by the lower and upper lug supports 28, 38. A shaped cylindrical passage 60 is also provided by the lower and upper lug supports 28, 38 and interconnects the cone 54 to the recess 36. The cone 54 and the shaped cylindrical passage 60 cooperate to provide a wire insertion passage having a reduced cross-sectional area extending to the recess 36 and which is designed to compress the individual wire strands of the stripped end 24 to a diameter that is slightly smaller than an open end 55 of the lug 32. The overall profile of the wire insertion passage also prevents the wire strands from becoming bent or deformed in a manner that would interfere with their insertion cleanly into the open end 55.

In the example, the cone 54 has first and second diameters 56, 58, providing a smooth tapering right cone shape, in the example. The first diameter 56 is greater than the second diameter 58. The shaped cylindrical passage 60 has third and fourth diameters 62, 64. The third dimeter 62 is greater than the fourth diameter 64, and the third diameter is the same as the second diameter 58, in the example. The fourth diameter 64 is slightly smaller than the diameter of the open end 55 of the lug 32. The shaped cylindrical passage 60 includes an annular radius 66 that provides a transitional portion from the third diameter 62 to the fourth diameter 64. This shape facilitates compression of the wire strands without producing defects as the stripped end is pushed through the wire insertion passage as compared to a simple tapered shape, although such a shape or other shapes may be used.

A third alignment feature includes a tab 50 providing a portion of the cone 54 on one of the lower and upper lug supports 28, 38 (one in each in the example) and a complementary interlocking notch 52 provided on the other of the lower and upper lug supports 28, 38 (one in each in the example). The tab 50 and the notch 52 mate with one another in a closed lug support assembly configuration (FIG. 4). The third alignment feature provides a jog in the cone's seam or mating surface (see, FIG. 5C), which acts as a smoother guide for the wire strands during insertion.

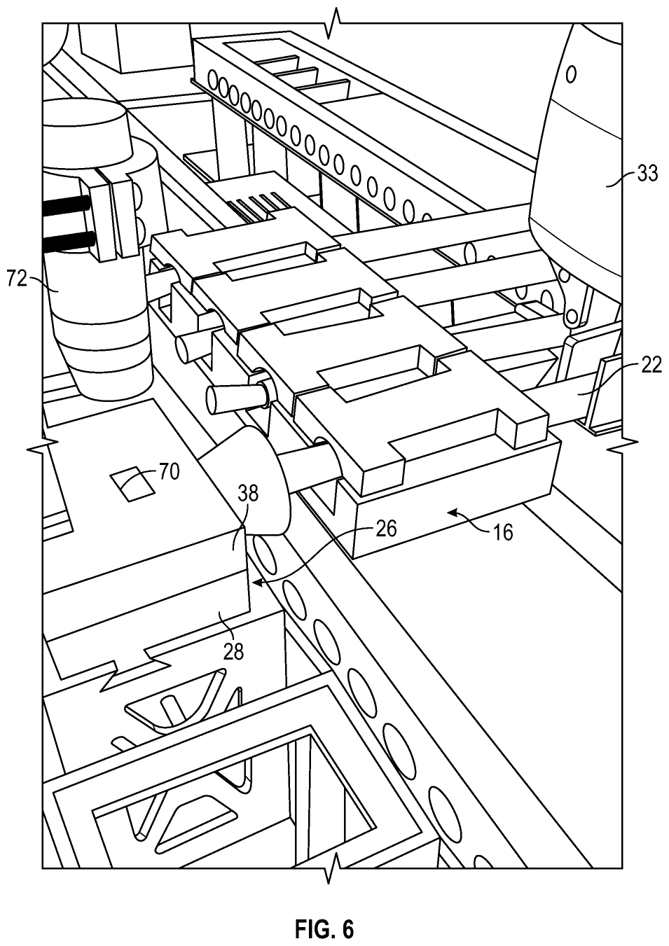

The system 10 includes multiple cameras 72,82 arranged at multiple inspection locations including the lug support assembly 26 and the wire lug crimper 86. Other cameras at other locations may also be used in the KonnectAI system. The cameras 72, 82 are configured to visually monitor at least one of the wire 22 and the lug 32. Example monitored features include identifying uninserted wire strands, an unseated stripped end, and a poor crimp. In the example, the camera 72 is mounted to the upper lug support 38 via a bracket 68, as shown in FIG. 4, which may be secured via holes 74 or formed integrally with the upper lug support 38. The camera 72 is aimed at a window 70 in the upper lug support 38 to provide visual access to an interface (FIG. 6) between the stripped end 24 and the open end 55 of the lug 32, as schematically shown in FIG. 5B.

In the example, the upper lug support 38 includes a protrusion 78 that is received in an opening 76 in the lug 32 when the lug support assembly 26 (FIG. 5B) is in the closed configuration about the lug 32.

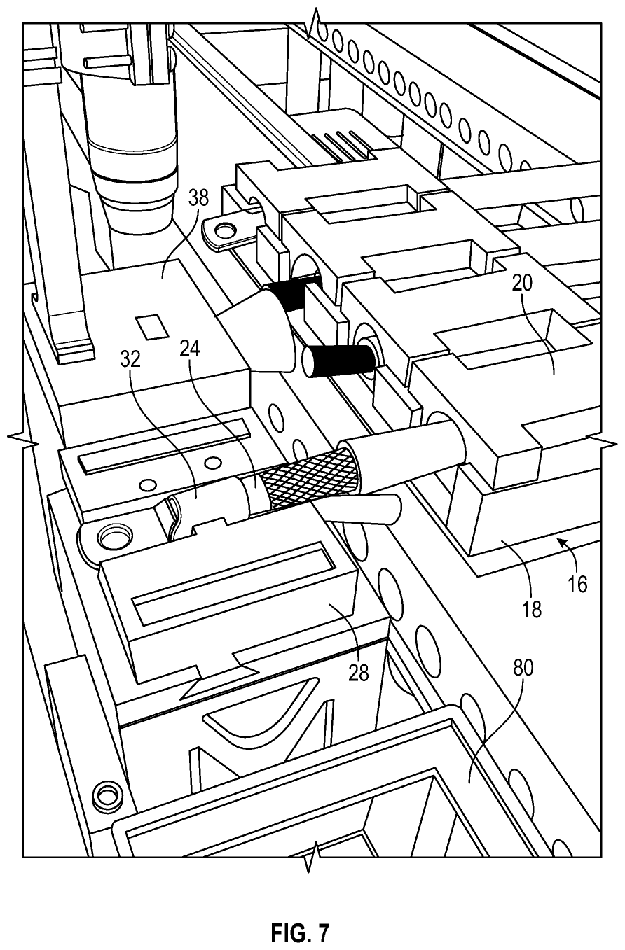

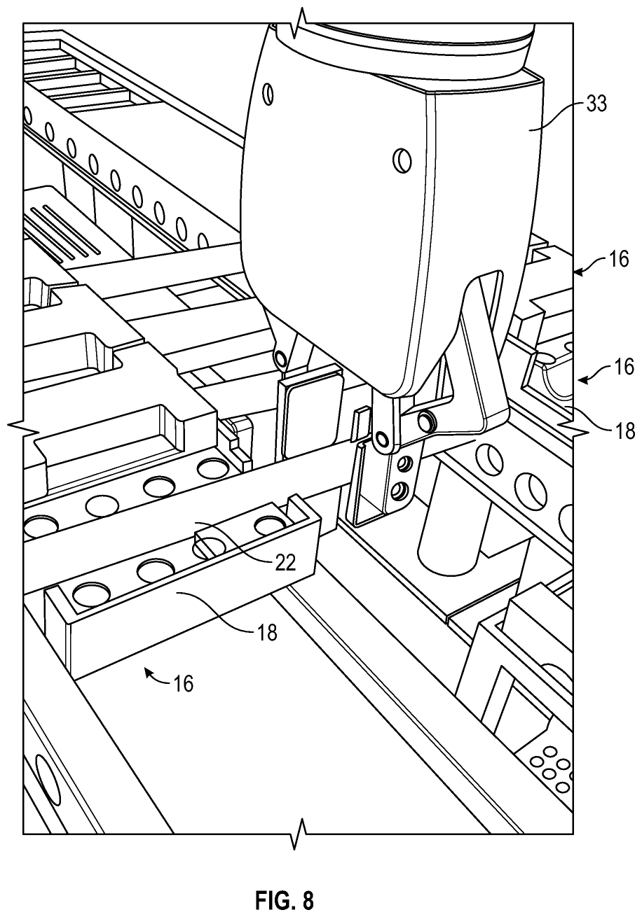

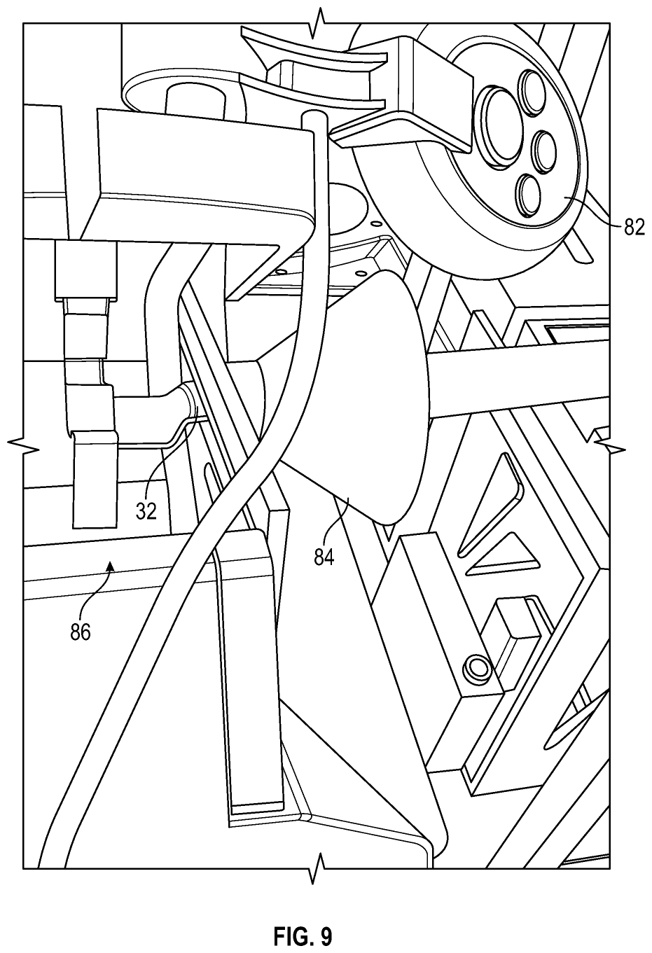

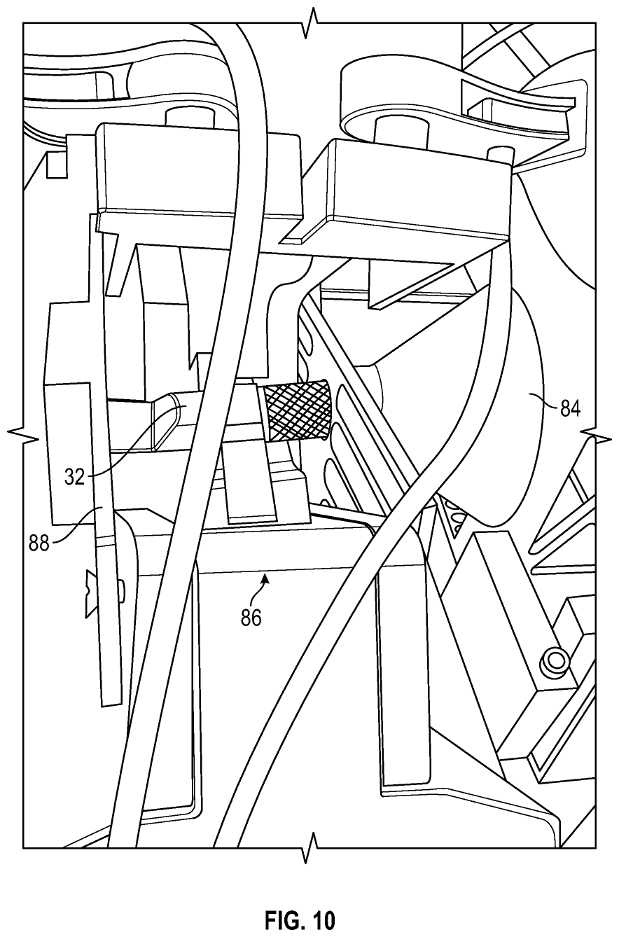

As shown in FIG. 7, the stripped end 24 can only be inserted partially into the open end 55 of the lug 32, as the shaped cylindrical portion 60 is not wide enough to accommodate the diameter of the wire 22 adjacent to the stripped end 24, such as the shielding. To this end, when the wire 22 is picked (FIG. 8) and pushed through a cone 84 into the crimper 86 (FIG. 9), the lug 32 is pushed against a stop 88 to fully seat the stripped end 24 into the lug 32 (FIG. 10). The wire lug crimper 86 is then able to crimp the lug 32 onto a stripped end 24 of the wire 22 with its opposing jaws 92, 94.

In the example system 10, multiple robotic arms 33 are used, which greatly speeds the crimping process. The robotic arms 33 are used to move the lug 32 from the picking location into the recess 36, move the second wire support 20 onto and off of the first wire support 18 onto pedestal 80, move the upper lug support 38 onto and off of the lower lug support 28, insert the stripped end 24 of the wire 22 into an open end 55 of the lug 32, and/or drag the lug 32 with the inserted stripped end from the lower lug support 28 to the wire lug crimper 86. The robotic arms 33 may be used for fewer, additional or different operations that described.

In operation, a method of securing a lug 32 to a wire 22 comprising the steps of supporting a wire 22 at a location spaced from a stripped end 24 of a wire 22. In one example, the supporting step includes retaining the wire 22 at least two locations that are spaced apart from one another along a length of the wire 22, which enables more accurate, repeatable wire picking, pushing and/or dragging.

A lug 32 is picked from the lug feeder 30 and placed in a lower lug support 28. The upper lug support 38 is mounted onto the lower lug support 28 to retain the lug 32 between the lower and upper lug supports 28, 38. During mounting the upper lug support 38 is aligned with the lower lug support 28 using at least one alignment feature. To further ensure lug alignment with the wire during wire insertion, an end of the lug is captured by a protrusion 78 extending through the opening 76 in the lug 32.

The stripped end 24 is pushed through the cone 54 and into the shaped cylindrical passage 60 provided by the lower and upper lug supports 28, 38. The shaped cylindrical passage 60 compresses the stripped end 24 as the stripped end is progressively slid from the first diameter 56, through the second and third diameters 58, 62 along the annular recess 66 and past the fourth diameter 64. In this manner, the compressed stripped end 24 is inserted into the open end 55 of the lug 32.

The stripped end 24 is further seated into the lug 32 by abutting the lug 32 against a stop 88, after which and the lug 32 is crimped onto the seated wire 22. The above steps may be performed in a different order than described and/or simultaneously.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method of securing a lug to a wire, comprising the steps of:
supporting a wire at a location spaced from a stripped end of a wire;
placing a lug in a lower lug support;
mounting an upper lug support onto the lower lug support to retain the lug between the lower and upper lug supports;
pushing the stripped end through a cone and into a shaped cylindrical passage provided by the lower and upper lug supports, wherein the shaped cylindrical passage compresses the stripped end; and
inserting the compressed stripped end into an open end of the lug.

2. The method of claim 1, wherein the supporting step includes retaining the wire at least two locations that are spaced apart from one another along a length of the wire.

3. The method of claim 1, wherein the placing step includes robotically picking the lug from a lug feeder.

4. The method of claim 1, wherein the mounting step includes aligning the upper lug support to the lower lug support with at least one alignment feature.

5. The method of claim 4, wherein the at least one alignment feature includes at least one of a magnet and ferrous material, a complementary interlocking tab and notch, and a pin with a complementarily shaped hole.

6. The method of claim 1, wherein the mounting step includes capturing an end of the lug having an opening with a protrusion provided in at least one of the lower and upper lug supports and extending through the opening.

7. The method of claim 1, wherein the cone has first and second diameters, the first diameter greater than the second diameter, and the shaped cylindrical passage has third and fourth diameters, the third diameter greater than the fourth diameter, the pushing step includes sliding the stripped end from the first diameter, through the second and third diameters and past the fourth diameter.

8. The method of claim 7, wherein the shaped cylindrical passage includes an annular radius that provides a transitional portion from the third diameter to the fourth diameter.

9. The method of claim 1, comprising the steps of seating the stripped end into the lug against a stop, and crimping the lug onto the seated wire.

10. A lug support assembly for supporting a lug during insertion of a stripped end of a wire, comprising:
a lower lug support with a recess configured to receive a lug;
an upper lug support configured to be mounted onto the lower lug support;
an alignment feature provided between the lower and upper lug supports;
a cone provided by the lower and upper lug supports; and
a shaped cylindrical passage provided by the lower and upper lug supports, the shaped cylindrical passage interconnecting the cone to the recess, the cone and the shaped cylindrical passage providing a wire insertion passage having a reduced cross-sectional area extending to the recess.

11. The lug holder of claim 10, wherein the alignment feature includes a magnet provided on one of the lower and upper lug supports, and the alignment feature includes a ferrous material provided on the other of the lower and upper lug supports, the magnet and the ferrous material mating with one another in a closed lug support assembly configuration.

12. The lug holder of claim 10, wherein the alignment feature includes a tab providing a portion of the cone on one of the lower and upper lug supports, and the alignment feature includes a complementary interlocking notch provided on the other of the lower and upper lug supports, the tab and the notch mating with one another in a closed lug support assembly configuration.

13. The lug holder of claim 10, wherein the alignment feature includes a pin provided on one of the lower and upper lug supports, and the alignment feature includes a complementarily shaped hole provided on the other of the lower and upper lug supports, the pin and the hole mating with one another in a closed lug support assembly configuration.

14. The lug holder of claim 10, wherein the cone has first and second diameters, the first diameter greater than the second diameter, and the shaped cylindrical passage has third and fourth diameters, the third diameter greater than the fourth diameter, and wherein the shaped cylindrical passage includes an annular radius that provides a transitional portion from the third diameter to the fourth diameter.

15. The lug holder of claim 10, wherein a window is arranged in the upper lug support and in communication with the recess, comprising a bracket on the upper lug support to which a camera is mounted, the camera aimed at the window and configured to monitor an interface between a stripped end of a wire and an open end of the lug.

16. A wire lug crimping system, comprising:
a wire support assembly configured to retain a portion of a wire;
a lug feeder configured to supply lugs to a lug picking location;
a lug support assembly including lower and upper lug supports, the lower lug support with a recess configured to receive a lug, the upper lug support configured to be mounted onto the lower lug support, and an alignment feature provided between the lower and upper lug supports;
a wire lug crimper configured to crimp the lug onto a stripped end of the wire;
at least one robotic arm configured to:
move the lug from the picking location into the recess;
move the upper lug support onto and off of the lower lug support;
insert the stripped end of the wire into an open end of the lug; and
drag the lug with the inserted stripped end from the lower lug support to the wire lug crimper; and
multiple cameras arranged at multiple inspection locations including the lug support assembly and the wire lug crimper, the cameras configured to visually monitor at least one of the wire and the lug.

17. The system of claim 16, wherein the wire support assembly includes multiple wire supports spaced apart from one another, each wire support including first and second wire supports configured to be secured about the wire, the multiple wire supports arranged on a conveyor and configured to move between multiple discrete positions.

18. The system of claim 17, wherein one of the at least one robotic arm is configured to move at least one of the second wire supports between first and second positions, the first position has the second wire support on the first wire support, and the second position has the second wire support removed relative to the wire support half.

19. The system of claim 16, wherein one of the cameras is mounted to the upper lug support via a bracket, the camera aimed at a window in the upper lug support, the window providing visual access to an interface between the stripped end and the open end of the lug.

20. The system of claim 16, wherein a cone is provided by the lower and upper lug supports, and a shaped cylindrical passage provided by the lower and upper lug supports, the shaped cylindrical passage interconnecting the cone to the recess, the cone and the shaped cylindrical passage providing a wire insertion passage having a reduced cross-sectional area extending to the recess.
